(19) United States
(12) Patent Application Publication
(10) Pub. No.: US 2010/0133205 A1
(43) Pub. Date: Jun. 3, 2010

(54) Remote Actuator for a Fuel Water Separator on a Vehicle

(75) Inventor: Steven P. Kuhn, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/327,264

(22) Filed: Dec. 3, 2008

(51) Int. Cl. B01D 17/02; B01D 21/34

(52) U.S. Cl. 210/799; 210/109

(57) ABSTRACT

An apparatus includes a remotely-actuable actuator connected to a drain valve of a fuel-water separator for manually remotely operating the drain valve, and an elongated drain tube connected to the separator's drain port for dispensing liquid separated by the separator to a desired remote location for collection. The apparatus can be installed in a convenient location in a vehicle, such as to the vehicle's fender well, where it is easily operated and where waste is easily collected. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### BACKGROUND

This device relates to fuel-water separators, such as are used on vehicles having diesel engines. However, use of this device is not believed to be limited to only vehicle-mounted systems.

Fuel-water separators are commonly provided in vehicles having diesel fueled engines, in order to eliminate water and other contaminants from the diesel fuel prior to use by the vehicle engine. These fuel-water separators have a chamber wherein the water and other contaminants that have been separated from the diesel fuel are stored temporarily. The contents of this chamber must be periodically removed, typically on a regular basis by the driver of the vehicle. However, the fuel-water separators are often mounted to vehicles behind the vehicle's fender extension. In this installed position, the drain valve, which is periodically used to remove collected water/sediment/contaminates from the system, may not be visible or accessible to a person in the standing position, even with the hood raised. In order to reduce spillage and make the process of periodically removing the collected water/sediment/contaminants from the system easier and more efficient for the driver of the vehicle, a way to remotely actuate the fuel-water separator and a way to collect the removed water/sediment/contaminant material at or near the point of such actuation is herein described.

### SUMMARY

In one aspect, an apparatus is provided for remotely actuating a fuel-water separator in a vehicle, the separator having a drain valve and a drain port. The apparatus includes a remotely-actuable actuator adapted for connection to the drain valve for remotely operating the drain valve. An elongated drain tube is adapted for connection to the drain port for dispensing liquid separated in the separator to a desired remote location for collection.

In a narrower aspect, the actuator of the apparatus comprises a flexible member that is sufficiently torsionally stiff to communicate torque along its length, yet sufficiently bendable so that the torque can be communicated along a non-linear path. The actuator may be several inches to about a foot in length.

In another aspect, a vehicle includes a fuel-water separator, a remotely-actuable actuator connected to the drain valve of the separator, and an elongated drain tube connected to the drain port of the separator for dispensing liquid separated in the separator to a desired remote location for collection.

In a narrower form, the actuator and/or the drain tube are connected to the vehicle in a convenient location for easy access, such as at the vehicle's fender well.

In another aspect, an apparatus is provided for remotely actuating and collecting liquid waste from a storage unit for petroleum liquids, the storage unit having a separator with a drain valve and a drain port. The apparatus includes an elongated flexible torque-transmitting member connected to the drain valve for remotely actuating same. An elongated tube is connected to the drain port for dispensing liquid separated in the separator to a remote location for collection.

In another aspect, a method for remotely actuating a fuel-water separator in a vehicle and for collecting waste from the same includes providing a vehicle having a fuel-water separator with drain valve and drain port. The method includes attaching an elongated torque-transmitting member to the drain valve for remotely actuating the fuel-water separator, and attaching an elongated tube to the drain port for dispensing liquid separated in the separator to a remote location for collection.

The apparatus provides a fast/quick/easy/convenient/sanitary operation of a valve to allow draining of fuel, water, sediment, or other materials from the fuel-water separator of other similar material holding device or valve. In particular, it provides for a more convenient and sanitary operation, which increases the likelihood and frequency of the use of the device, thus likely adding to the performance of the entire system to which it is connected.

These and other aspects and features of the present apparatus will be understood and appreciated by those skilled in the art upon studying the following specification, claims, and appended drawings. As described above, the Remote Actuator for a Fuel-Water Separator and a vehicle made with this apparatus provides a number of advantages, some of which have been described above and others of which are inherent in the invention. Also, modifications may be proposed to the Remote Actuator for a Fuel-Water Separator or a vehicle made with this apparatus without departing from the teachings herein.

### BRIEF DESCRIPTION OF DRAWINGS

FIGS. 1-2 are top and side schematic views of a truck with diesel engine, fuel-water separator, and remote actuator and drain for remote draining of the separator.

FIGS. 3-4 are perspective top/side views of a truck's engine compartment, FIG. 3 including a fender well, and FIG. 4 having the fender well removed to better show components thereunder.

### DETAILED DESCRIPTION OF THE DRAWINGS

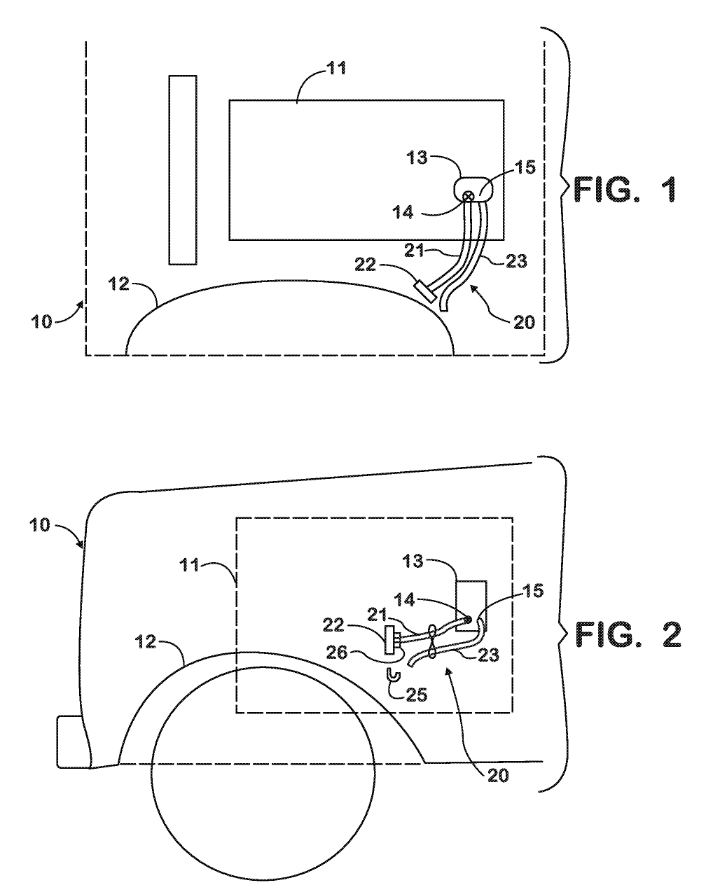

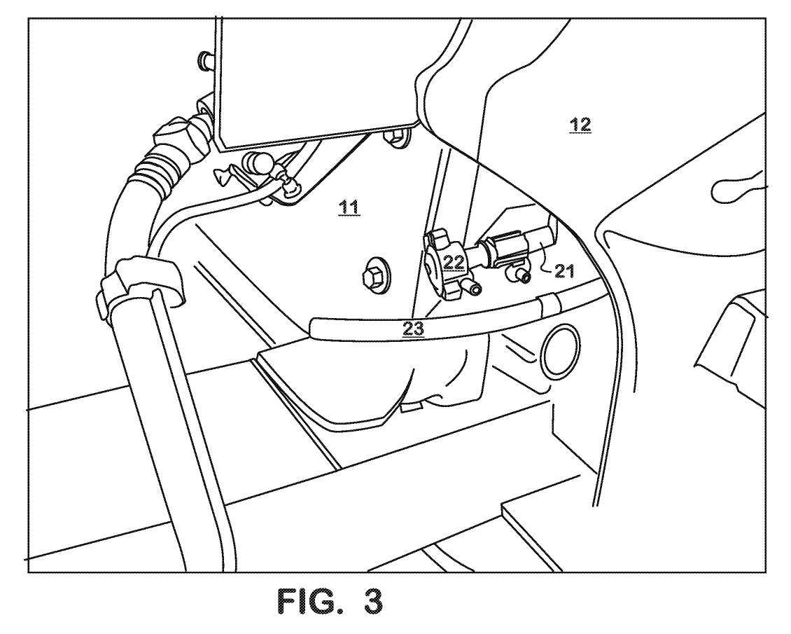

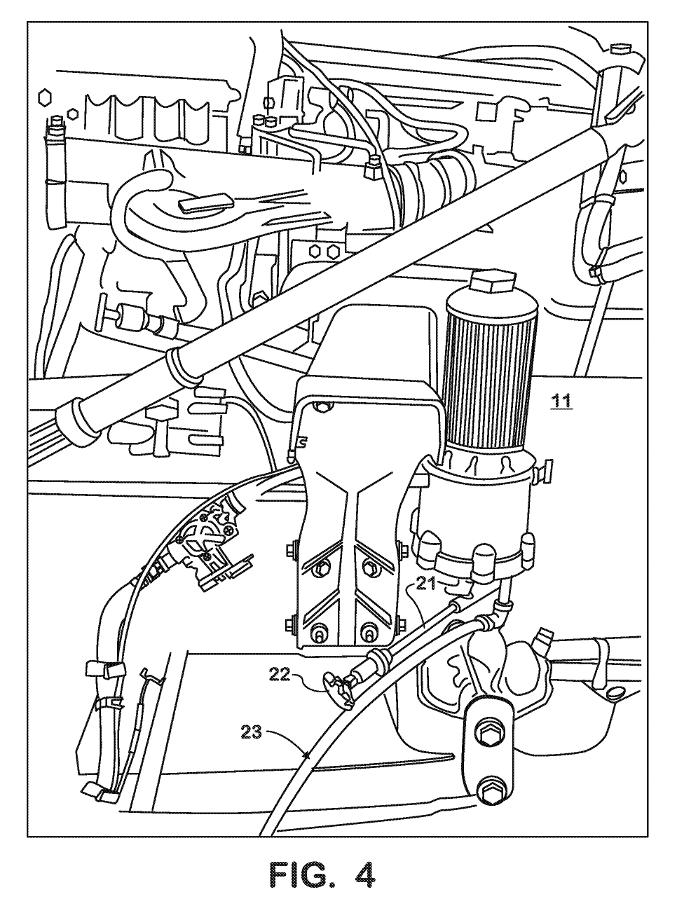

A vehicle 10 (FIGS. 1-4) is illustrated having a diesel engine 11, a fender well 12 (also called “wheel well”), and a fuel-water separator 13, with the separator 13 being positioned in a difficult-to-reach position. The fuel-water separator 13 includes a drain valve 14 and a drain port 15 for discharging waste material separated from the vehicle's fuel.

The present apparatus 20 (FIG. 1-2) includes a torque-transmitting flexible member 21 (also called a “tube”) attached to the drain valve 14 of the fuel-water separator 13. The illustrated flexible member 21 is a flexible tube that is sufficiently torsionally stiff to communicate torque from a remote handle 22 at one end to the valve 14 at its other end for remotely actuating the valve 14, but that is flexible such that it can be extended around engine components and other components interfering with a straight-line shot between the valve 14 and the remote actuator's handle 22. The apparatus 20 further includes a drain tube 23 (such as a flexible hose or tube) connected to the separator's drain port 15 to convey waste material from the separator 13 to a remote convenient location, such as near the handle 22 on the flexible tube member 21, so that a service person can hold a waste container while operating the handle 22. The tubes 21 and 23 may be secured together for convenient routing and positioning in the vehicle engine compartment.

It is contemplated that a removable waste container/receptacle can be removably attached to a hanger or mount 25 (or platform) at the drop site of the drain tube 23, and/or that a hook-like hanger or platform can be positioned for supporting a container at the drop site. It is contemplated that the tubes 21 and 23 can be loosely or fixedly secured together for convenient routing (such as with ties or brackets) and to facilitate fixing their routed location so that they do not extend into areas of concern. It is contemplated that a bearing, bracket and/or other mount 26 can be used to secure the handle 22 (and end of tubes 21 and 23) in fixed locations so that they are easily located and used when maintenance is being provided.

The present method includes attaching a length of flexible tubing (21) to the fuel-water separator's drain valve (14) on one end and a hand knob (24) on the other end, and routing the tubing (21) to a location (in this case near the fender well 12) where it can be accessed by a person from a standing position. Another section of tubing (i.e., drain tube 23) is attached to the drain port (15) on the separator (13). The other end of the drain tube (23) is routed to the same location as the remote hand knob (24) that activates fuel-water separator drain valve (14). The flexible tube member (21) allows a torsional force and rotational movement to be transferred along a path that may or may not have bends in singlular or multiple directions. The drained contents from the drain tube (23) can be collected at the same location as the remote hand knob (24), thus allowing a same person to control both the initiation of discharging waste material as well as collection of the drainage of waste materials from the fuel water separator (13).

Notably, it is contemplated that the present apparatus/design could be used for remotely draining and collecting materials in a controlled fashion from other gas, liquid, particulate, or mixtures of same in holding/collecting devices, including portable and non-portable tanks.

As noted, the flexible tube 21 transfers torque and twisting motion from the hand knob 24 to the drain valve 14, a torsional strength of the tube 21 depends on the functional requirements of the application. Advantageously, the drain tube 23 extends along a non-linear tortuous path from the drain valve exit port around the various engine components and around vehicle components in the engine compartment to the vicinity of the remote drain valve hand knob 24. In this case the remote hand knob 24 and torque transmitting tube is operably connected to the fuel-water separator 13 such as by being friction fit, clamped, screw-attached, or otherwise anchored/attached to the valve. Such fuel-water separators are well known in the art. For example, one such separator assembly is manufactured by Davco Corporation. However, it is contemplated that the present apparatus could be used with other devices made by other manufacturers.

The remote knob 24 allows the practically inaccessible drain valve 14 to be operated with one hand from a convenient location/human position, and the remote drain tube 23 allows the drained materials to be collected by the same person at the same location while holding a collection device/cup with his/her other hand. The convenience of this device/system also protects the environment from unplanned spills of diesel fuel and/or other environmentally-hazardous gasses/liquids/solids in this or other applications. It also facilitates and encourages good maintenance practices.

While specific embodiments have been described in detail in the foregoing detailed description and illustrated in the accompanying drawings, those with ordinary skill in the art will appreciate that various permutations of the invention are possible without departing from the teachings disclosed herein. Accordingly, the particular arrangements disclosed are meant to be illustrative only and not limiting as to the scope of the invention, which is to be given the full breadth of the appended claims and any and all equivalents thereof. Other advantages to a Remote Actuator for a Fuel-Water Separator and a vehicle made with this system may also be inherent in the invention, without having been described above.

1. An apparatus for remotely actuating a fuel-water separator in a vehicle, the separator having a drain valve and a drain port, comprising:
a remotely-actuable actuator adapted for connection to the drain valve for remotely operating the drain valve; and
an elongated drain tube adapted for connection to the drain port for dispensing liquid separated in the separator to a desired remote location for collection.

2. The apparatus defined in claim 1, wherein the actuator is an elongated torque-transmitting member adapted for manual actuation.

3. The apparatus defined in claim 2, wherein the torque-transmitting member is sufficiently bendable so that the torque-transmitting member can be routed around interfering objects and yet the torque-transmitting member is sufficiently torsionally stiff to communicate torque along its length around the interfering objects.

4. The apparatus defined in claim 2, wherein the actuator comprises a flexible tube.

5. The apparatus defined in claim 2, wherein the elongated torque-transmitting member and the elongated drain tube are secured together in at least one location along their lengths.

6. The apparatus defined in claim 1, including a fuel-water separator and including the actuator and drain tube attached to the separator.

7. A vehicle including the separator and the apparatus defined in claim 1, the actuator being connected to the drain valve, and the elongated drain tube being connected to the drain port.

8. The vehicle defined in claim 7, wherein the vehicle includes a fender well, and wherein the actuator and the drain tube include ends terminating near the fender well.

9. The vehicle defined in claim 7, wherein the actuator is elongated and flexible, but sufficiently torsionally stiff to transmit torque along a non-linear path.

10. The vehicle defined in claim 7, wherein the actuator and drain tube extend generally along parallel paths and terminate at locations near each other.

11. The vehicle defined in claim 7, wherein the actuator includes a handle at its outer end for manual operation.

12. The vehicle defined in claim 7, wherein the vehicle includes a mount near an outer end of the actuator to retain and facilitate operation of the actuator.

13. The vehicle defined in claim 7, including a bearing at an operator-end of the actuator securing the actuator to the vehicle in a manner that facilitates rotation of the actuator.

14. The vehicle defined in claim 7, wherein the vehicle includes a mount for supporting a receptacle under an outer end of the drain tube.

15. An apparatus for remotely actuating and collecting liquid waste from a storage unit for petroleum liquids, the storage unit having a separator with a drain valve and a drain port, comprising:
an elongated flexible torque-transmitting member connected to the drain valve for remotely actuating same; and
an elongated tube connected to the drain port for dispensing liquid separated in the separator to a remote location for collection.

16. A method for remotely actuating a fuel-water separator in a vehicle and for collecting waste from the same, the method comprising steps of
providing a vehicle having a fuel-water separator with drain valve and drain port;
attaching an elongated torque-transmitting member to the drain valve for remotely actuating the fuel-water separator; and
attaching an elongated tube to the drain port for dispensing liquid separated in the separator to a remote location for collection.
